(19) United States
(12) Patent Application Publication
(10) Pub. No.: US 2025/0147799 A1
(43) Pub. Date: May 8, 2025

(54) SYSTEMS AND METHODS FOR TASK MANAGEMENT

(71) Applicant: Xilinx, Inc., San Jose, CA (US)

(72) Inventors: Thomas Calvert, Cambridge (GB); Ripduman Sohan, San Jose, CA (US); Dmitri Kitariev, Irvine, CA (US); Kimon Karras, Köln (DE); Stephan Diestelhorst, Cambridge (GB); Neil Turton, Cambridge (GB); David Riddoch, Cambridge (GB); Derek Roberts, Cambridge (GB); Kieran Mansley, Cambridge (GB); Steven Pope, Cambridge (GB)

(73) Assignee: Xilinx, Inc., San Jose, CA (US)

(21) Appl. No.: 18/501,868

(22) Filed: Nov. 3, 2023

(51) Int. Cl. G06F 9/48

(52) U.S. Cl. CPC G06F 9/4806

(57) ABSTRACT

A computer-implemented method for task management can include managing performance of a task on a message by a plurality of circuits. In some aspects, the task can comprise a sequence of processings to be performed on the message and each circuit of the plurality of circuits performing a processing of the sequence of processings. In some aspects, the method can include routing, based on the sequence, a first information regarding the task to a first circuit of the plurality of circuits to perform a first processing of the sequence of processings on the message; receiving, from the first circuit, an output of the first processing; and routing, based on the sequence of processings identified for the task, a second information regarding the task to a second circuit of the plurality of circuits to perform a second processing that follows the first processing in the sequence of processings.

### BACKGROUND

Conventional computer systems can receive requests to process messages using circuits. Typically, the messages are processed in a sequential, predetermined manner without flexibility. In addition to a limited processing performance ceiling, this paradigm is susceptible to errors that can propagate and further hinder performance. Such systems also require costly and time intensive human attention to mitigate programming issues.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for task management.

FIG. 2 is a block diagram of an example system for task management.

FIG. 3 is a flow diagram for an example method for managing tasks.

FIG. 4 is a block diagram of an additional example system for task management.

Throughout the drawings, identical reference characters and descriptions indicate similar, but not necessarily identical, elements. While the example implementations described herein are susceptible to various modifications and alternative forms, specific implementations have been shown by way of example in the drawings and will be described in detail herein. However, the example implementations described herein are not intended to be limited to the forms disclosed. Rather, the present disclosure covers all modifications, equivalents, and alternatives falling within the scope of the appended claims.

### DETAILED DESCRIPTION OF EXAMPLE IMPLEMENTATIONS

The following description sets forth numerous specific details such as examples of specific systems, components, methods, and so forth, in order to provide a good understanding of the embodiments. It will be apparent to one skilled in the art, however, that at least some embodiments may be practiced without these specific details. In other instances, well-known components or methods are not described in detail or are presented in a simple block diagram format in order to avoid unnecessarily obscuring the embodiments. Thus, the specific details set forth are merely exemplary. Particular implementations may vary from these exemplary details and still be contemplated to be within the spirit and scope of the embodiments.

One embodiment of a computing system includes multiple processing units that communicate with memory and other devices via a data interconnect fabric. The data interconnect fabric connects multiple nodes in an arbitrary topology, and conveys messages between the nodes. Nodes may include various functional blocks, such as memory controllers, processor core complexes, input/output (I/O) hubs, and intra-socket extenders, among others. Messages communicated between nodes are used for various purposes, including maintaining memory coherence and transmitting interrupts generated by peripheral devices through I/O hubs.

The present disclosure describes examples of systems and methods for task management. Included are examples of techniques for managing messages, tasks to be performed on messages, and task descriptions corresponding to the tasks to support higher data transport rates between processing circuits and communication paths, such as within a processing unit, system on a chip, or other integrated circuit, or in other contexts. The techniques included herein can, in some implementations, enable message processing systems to have high message rate performance; diminishing monopolization problems when sharing bandwidth, memory, or any other resource; and/or enforcement of access control and security.

In some implementations, a task controller is operatively connected to a plurality of processing circuits and/or components that perform tasks with respect to messages based on a task description. In some implementations, the task controller can act as a switch to route task descriptions between components and arbitrate between conflicting task descriptions. In some aspects, the task controller can route task descriptions to subsequent hops in a processing sequence. In some aspects, the task controller can enforce security & bandwidth policies. In some aspects, the task controller can schedule work (e.g., tasks) to avoid head of line blocking (HoLB) events. In some aspects, the task controller can provide telemetry or status updates regarding a given task.

In some aspects, a task controller can receive a task description from a component, inspect the task description content, and queue the task description to the next component. In some implementations, where two or more message processing systems are implemented along each other, the task controller of one system can pass a task description to a task controller in another system. In some implementations, the task controller can route a task by looking up one or more fields in a table of information regarding routing of tasks.

In some aspects, the task controller can arbitrate between tasks found at the heads of tasks queues leading to each component. In some implementations, the arbitration function is performed independently and/or in parallel for each component. In some implementations, for each component, the task controller can determine which tasks are eligible to continue processing, arbitrates between all the eligible tasks, dequeues the selected task, and passes it to the component.

In some aspects, a task's eligibility for processing can be determined by the resources that the task may need to complete the next processing operation without stalling (or in some cases being able to progress with a sufficiently low probability of stalling). In some aspects, the task description can indicate to the task controller or allow the task controller to determine which resources are needed by the task.

In some implementations, the techniques described herein relate to a method for task management. In some implementations, the method can include managing performance of a task on a message by a plurality of circuits of a processing device, the task comprising a sequence of processings to be performed on the message and each circuit of the plurality of circuits performing a processing of the sequence of processings. In some implementations, managing performance of the task can include routing, based on the sequence of proceedings for the task, a first information regarding the task to a first circuit of the plurality of circuits to perform a first processing of the sequence of processings on the message. In some implementations, the method can include receiving, from the first circuit, an output of the first processing; and routing, based on the sequence of processings identified for the task, second information regarding the task to a second circuit of the plurality of circuits to perform a second processing that follows the first processing in the sequence of processings.

In some implementations, the method can performed by a controller communicatively coupled to each circuit of the plurality of circuits, wherein each circuit of the plurality of circuits can be connected to the controller via one or more interfaces, wherein each circuit of the plurality of circuits comprises one or more queues for output of tasks that are to be passed to one or more other circuits of the plurality of circuits. In some implementations, the routing to a circuit of the plurality of circuits comprises routing to an interface of the circuit from a queue of another circuit of the plurality of circuits.

In some implementations, the task can be a first type of task, the first type of tasks can comprise the sequence of processings performed with the plurality of circuits; and a second type of task can comprise a second sequence of processings performed with at least some of the plurality of circuits, the second sequence of processings being different from the sequence of processings.

In some implementations, the task can be one of a plurality of tasks, the plurality of tasks organized into at least a first flow of tasks; wherein managing performance of the task can comprise selecting, at a time, between one or more tasks for which information is to be routed to circuits of the plurality of circuits for processing; and wherein managing performance of the task comprises ensuring that tasks of the first flow of tasks are processed by circuits of the plurality of circuits according to an order of the tasks in the first flow.

In some implementations, the message can comprise a command and/or data and the task comprises a task description comprising information regarding performance of the task. In some implementations, routing the first information regarding the task to the first circuit and the second information regarding the task to the second circuit can comprise routing, at a time, at least some of the task description at the time.

In some implementations, each of the plurality of circuits is communicatively coupled to a shared memory and the command and/or the data for the message is stored in a message buffer in the shared memory. In some implementations, the information regarding performance of the task can be stored in the shared memory separate from the command and/or the data; and the task description can comprise a pointer to a location storing the information regarding performance of the task, a pointer to the command and/or data, and/or a flow identifier identifying a flow of tasks with which the task is associated.

In some implementations, the first circuit can edit the flow identifier for the task. In some implementations, the second information regarding the task can have a different flow identifier for the task than the first information regarding the task.

In some implementations, routing the first and second information regarding the task to the first circuit and the second circuit, respectively, can comprise looking up the flow identifier in a table of information regarding routing of tasks.

In some implementations, the first circuit can be a programmable processing circuit. In some implementations, the method can further include receiving the message from a network.

In some implementations, the techniques described herein relate to a non-transitory computer-readable storage medium for storing instructions executable by a processor, the instructions comprising managing performance of a task on a message by a plurality of circuits of a processing device, the task comprising a sequence of processings to be performed on the message and each circuit of the plurality of circuits performing a processing of the sequence of processings. The method can also comprise managing performance of the task by routing, based on the sequence of proceedings for the task, first information regarding the task to a first circuit of the plurality of circuits to perform a first processing of the sequence of processings on the message; receiving, from the first circuit, an output of the first processing; and routing, based on the sequence of processings identified for the task, second information regarding the task to a second circuit of the plurality of circuits to perform a second processing that follows the first processing in the sequence of processings.

In some implementations, the method can be performed by a controller communicatively coupled to each circuit of the plurality of circuits, wherein each circuit of the plurality of circuits is connected to the controller via one or more interfaces and wherein each circuit of the plurality of circuits comprises one or more queues for output of tasks that are to be passed to one or more other circuits of the plurality of circuits. In some implementations, routing to a circuit of the plurality of circuits can comprise routing to an interface of the circuit from a queue of another circuit of the plurality of circuits.

In some implementations, the task can be a first type of task, the first type of tasks comprising the sequence of processings performed with the plurality of circuits; and wherein a second type of task comprises a second sequence of processings performed with at least some of the plurality of circuits, the second sequence of processings being different from the sequence of processings.

In some implementations, the task can be one of a plurality of tasks, the plurality of tasks organized into at least a first flow of tasks; and wherein managing performance of the task comprises selecting, at a time, between one or more tasks for which information is to be routed to circuits of the plurality of circuits for processing; and ensuring that tasks of the first flow of tasks are processed by circuits of the plurality of circuits according to an order of the tasks in the first flow.

In some implementations, the message can comprises a command and/or data; the task can comprise a task description comprising information regarding performance of the task; and routing the first information regarding the task to the first circuit and the second information regarding the task to the second circuit comprises routing, at a time, at least some of the task description at the time.

In some implementations, each of the plurality of circuits can be communicatively coupled to a shared memory and the command and/or the data for the message is stored in a message buffer in the shared memory. In some implementations, the information regarding performance of the task can be stored in the shared memory separate from the command and/or the data; and the task description can comprise a pointer to a location storing the information regarding performance of the task, a pointer to the command and/or data, and/or a flow identifier identifying a flow of tasks with which the task is associated.

In some implementations, the first circuit can edit the flow identifier for the task; and the second information regarding the task can have a different flow identifier for the task than the first information regarding the task.

In some implementations, the method further comprising wherein routing the first and second information regarding the task to the first circuit and the second circuit, respectively, comprises looking up the flow identifier in a table of information regarding routing of tasks. In some implementations, the first circuit can be a programmable processing circuit.

In some implementations, the techniques described herein relate to a device comprising a circuit configured to perform a method comprising managing performance of a task on a message by a plurality of circuits of the device, the task comprising a sequence of processings to be performed on the message and each circuit of the plurality of circuits performing a processing of the sequence of processings, the managing performance of the task comprising. In some implementations, the method further comprises routing, based on the sequence of proceedings for the task, first information regarding the task to a first circuit of the plurality of circuits to perform a first processing of the sequence of processings on the message; receiving, from the first circuit, an output of the first processing; and routing, based on the sequence of processings identified for the task, second information regarding the task to a second circuit of the plurality of circuits to perform a second processing that follows the first processing in the sequence of processings. The circuit configured to perform the method can be a controller in some implementations, and can be a controller arranged to execute instructions to perform the method in some such implementations.

Features from any of the implementations described herein can be used in combination with one another in accordance with the general principles described herein. These and other implementations, features, and advantages will be more fully understood upon reading the following detailed description in conjunction with the accompanying drawings and claims.

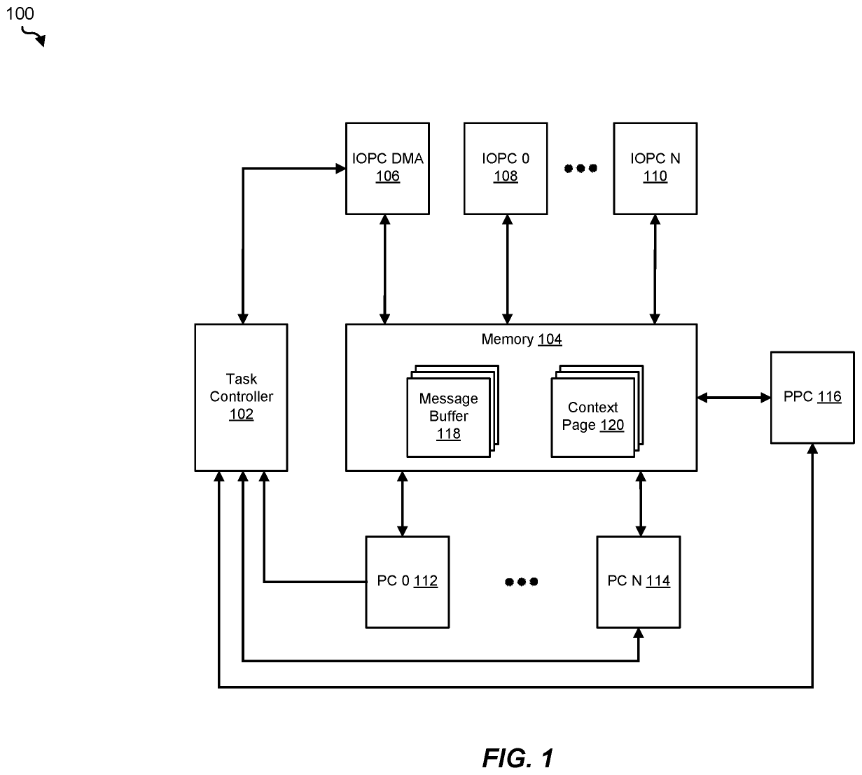

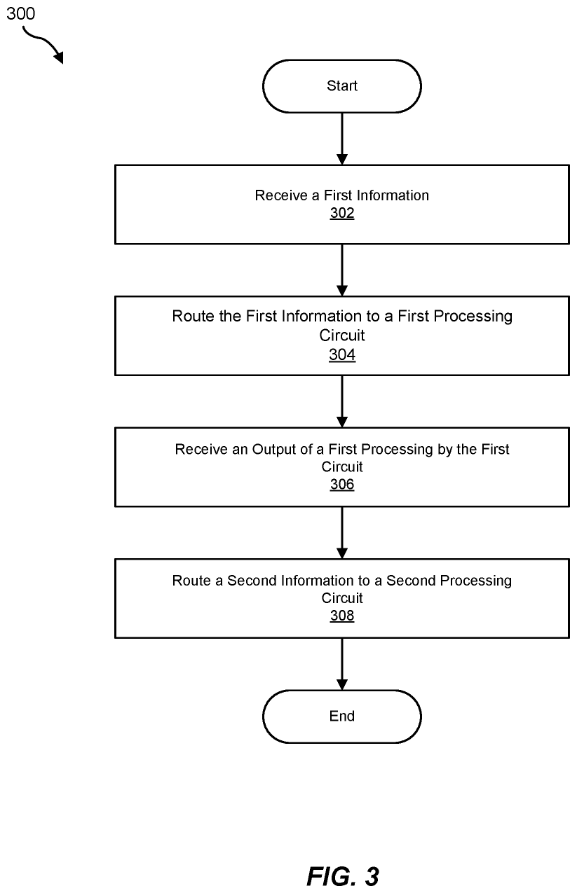

Below are provided, with reference to FIG. 1-FIG. 4, detailed descriptions of example systems for memory management. Detailed descriptions of examples of computer-implemented methods are also provided in connection with FIG. 3. It should be appreciated that implementations are not limited to operating in accordance with any of the specific examples below, as other variations are possible.

FIG. 1 is a block diagram of an example system for task management. In some implementations, the system 100 of FIG. 1 can be included within a chip, such as an integrated circuit, system on a chip (SoC), or other chip. In some cases, the chip can be a processing unit, such as a data processing unit (DPU), data transform element (DTE), central processing unit (CPU), or graphics processing unit (GPU).

The system 100 can be configured to perform operations on or otherwise process messages. In some cases, a message can be a packet. In some cases, a message can include a command to be performed with respect to data. The operations or processes performed on messages can be referred to as tasks. System 100 can manage and track tasks through a task description. In some implementations, processing circuits or other system 100 components can process and analyze task descriptions to determine what operations or processes (e.g., a task) to perform on a given message associated with the task description. In some implementations, components of system 100 create and consume task descriptions.

In some cases, the messages can be communicated via a network. In some cases, such a network can be a network interface controller (NIC), network on a chip (NoC) interconnecting components within a chip, such as within a system on a chip (SoC). In some cases, the messages can be communicated via any suitable communication medium, as implementations are not limited in this respect.

Task controller 102 manages task descriptions within system 100. Task controller 102 can generally represents any type or form of hardware-implemented and/or computer-implemented processing circuit capable of interpreting and/or executing computer-readable instructions. Examples of the task controller 102 includes, without limitation, microprocessors, microcontrollers, data processing unit (DPUs), data transform element (DTE), Graphics Processing Units (GPUs), Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

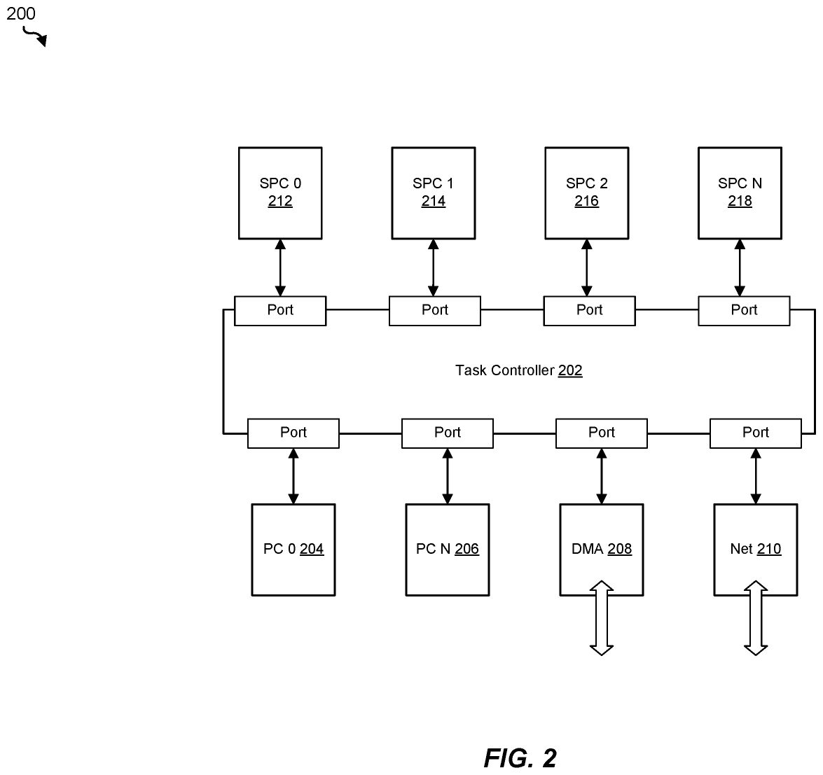

The Task controller 102 can be operatively connected to different components of system 100 and route or otherwise direct task items between components. In some implementations, a component can be a processing circuit such as processing circuit (“PC”) 0 112, any number of other processing circuits up to PC N 114 (where “N” is an integer, such as 4 or 8), or programmable processing circuit (“PPC”) 116. In some implementations, a component can be a network port, such as where system 100 processes information to be sent to or that is received from a network. In some implementations, a component can be an input/output processing circuit for Direct Memory Access (DMA) (e.g., IOPC DMA 106) operatively connected to external memory resources such as a Container Storage Interface (cSI) or Peripheral Component Interconnect Express (PCIe), such as when system 100 is processing information to be sent or received from other components of a processing device, such as a computer. Task controller 102 is discussed in further detail with respect to FIG. 2.

The several components of system 100 can interact with shared memory 104 to perform tasks and/or otherwise store, obtain, transform, or manipulate task descriptions, task description metadata (or context used interchangeably), messages, data contained within messages, and/or message metadata. In some implementations, the messages can arrive at the depicted components of system 100 via one or more data-in channels (e.g., IOPC DMA 106, IOPC 0 108, IOPC N 110). As should be appreciated from the foregoing, the data-in channels can in some cases be receiving data from an interconnect fabric of an integrated circuit, such as a network on a chip (NoC), network interface controller (NIC), or other interconnect. In other cases, the data-in channels can receive the messages from a different communication medium or mechanism. In some implementations, rather than a data-in channel, messages can be received via a different interface or input mechanism.

In some cases, messages can additionally or alternatively arrive at the depicted components of system 100 via one or more data paths of the system 100. The data paths of the system 100 can include one or more components to perform one or more operations on messages (e.g., PC 0 112, PC N 114, PPC 116), such as operations defined by one or more computer-readable instructions to be executed by the component(s) of the data path. In some cases, different data paths can include different components and/or be configured to perform different tasks in response to computer-readable instructions or be able to execute different computer-readable instructions. It should be appreciated, however, that variations are not limited to implementing data paths in any particular manner. In some implementations that include such data paths, there can be multiple or N-number of data paths.

In some implementations that include data paths within the system 100, such as that send data to or receive data from the components depicted in FIG. 1, messages, message metadata, task descriptions, and other data that is stored in memory 104 can be received from one or more of the data paths of the system 100. For example, messages that are to be processed per a task to be executed on a data path, or that results from performance of a task on a data path, can be stored in a set of the memory blocks in memory 104.

Memory 104 generally represents any type or form of volatile or non-volatile storage device or medium capable of storing data and/or computer-readable instructions. In one example, memory 104 can store, load, and/or maintain data on one or more memory blocks. Examples of memory 104 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

Memory 104 can be physical memory, and the physical memory can be subdivided into different regions for access (e.g., read/write), manipulation (e.g., inserts/deletes), and management. The subdivisions of the memory 104 can virtualize the memory for management. In some cases, subdividing the memory can enable increased efficiency in use of the memory, such as by enabling a reduction in memory collisions. Such memory collisions can include when a write operation is looking to use a same or similar part of memory as a read operation, when the read and write operations are being performed in parallel.

Memory 104 can be subdivided into blocks of equal size. For example, one or more blocks can be 16 bytes each. In another example, the memory 104 can include 128 of the memory blocks, where each has 16 bytes. A set of the memory blocks can, in some implementations be identified, by unique identifiers. In some implementations, the identifiers can be buffer identifiers for a buffer that is formed of the memory block(s) of a set of the memory blocks.

In some implementations, a set of one or more of the memory blocks can be arranged as a first-in, first-out (FIFO) queue. In such a queue, messages and/or task descriptions that are added to the queue in an order can be retrieved from the queue in the same order. In some implementations, one or more FIFO queues can be maintained for each of the channels and/or components.

In some implementations, memory 104 can include a message buffer 118 and/or a context page 120. In some implementations, message buffer 118 can include messages, data contained within messages, and/or message metadata. In some implementations, message buffer 118 can include one or more buffers. In some implementations, message buffer 118 can include plugin capsules and other data structures. In some implementations, message buffer 118 can be implemented as a linked list of 256 byte blocks (e.g., or some other predetermined block size) of memory in memory 104. In some implementations, message buffer 118 can be dynamically sized, growing or shrinking as needed.

In some implementations, context page 120 can include data related to a task such as an in-flight initial task state, a running task state, and other task metadata. Collectively the task data and metadata in context page 120 can be referred to as a task context. In some implementations, task context can include input and output metadata for the one or more processing circuits. In those implementations, task context can be used to read or write from context page 120 the sequence of processing circuits that will handle a task and/or process or perform the task with respect to a message.

The task context can be created when a task is created (e.g., in the form of a task item) by a component of system 100 and can exist until the task is completed. In some implementations, context page 120 can be implemented as one or more 256 bytes blocks (e.g., or some other predetermined block size) of memory in memory 104.

In some implementations, components of system 100 can access the message buffer 118 and the context page 120 in parallel. In some implementations, some components of system 100 may access the message buffer 118 sequentially (e.g., PC 0 112-PC N 114), other components (e.g., PPC 116) can access the message buffer 118 randomly.

System 100 can include a one or more processing circuits (e.g., PC 0 112-PC N 114), one or more programmable processing circuits (e.g., PPC 116), and one or more IOPC DMA 106 operatively connected to Task controller 102 and memory 104. In some implementations, memory 104 can be operatively connected to other components such as input/output processing circuits (e.g., IOPC 0 108-IOPC N 110).

In some aspects, a processing circuit (e.g., PC 0 112, PC N 114, PPC 116) can operate on or otherwise process messages based on an associated task description. Examples of processing circuits include, without limitation, microprocessors, microcontrollers, data processing unit (DPUs), Graphics Processing Units (GPUs), Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

In some aspects, some or all of the processing circuits (e.g., PC 0 112, PC N 114, PPC 116) can be implemented within one integrated circuit package. In some aspects, some or all of the processing circuits can be implemented on one printed circuit board. In some aspects, some or all of the processing circuits can be implemented within an FPGA.

In some implementations, a processing circuit can execute many tasks simultaneously. In some implementations, data and metadata in message buffer 118 can be local data. In other words, the data and metadata in message buffer 118 may only be accessed in the execution of a given task at any one time. In the implementations where a processing circuit is executing multiple tasks at a time, the data and metadata in message buffer 118 may only be owned by a single task.

In some aspects, while PC 0 112-PC N 114 may only access memory 104 sequentially, PPC 116 can access message buffer 118 and/or context page 120 randomly. In some implementations, PPC 116 can access stateful data stored in data structures referred to as maps. Maps can differ from data in memory 104 in that, maps may not be local, that is, they are specific to any task and can be accessed by multiple processing circuits executing different tasks in different systems. In some implementations, maps can be stored in and obtained from external memory (to system 100) and can be cached in memory 104.

In some aspects, PPC 116 can implement a data and/or metadata duplication function referred to herein as a Block Copy. Block Copy can allow the PPC 116 to create local copies of data in context page 120 and message buffer 118. In some implementations, Block Copy allows system 100 to implement message multicast. In some aspects, PPC 116 can include a circular pipeline of processing circuits where a task description is initially processed by a first processing circuit (designated as an entry point during programming of the PPC 116) and, then, is propagated through downstream processing circuits until it reaches a processing circuit previously designated as an exit point, thereby terminating the task processing. In some implementations, a user configuring a PPC 116 can configure the PPC 116 with a plurality of entry-point, exit-point pairs, each pair forming a pipe of processing circuits referred to as a virtual pipe. In some implementations, multiple virtual pipes can be implemented simultaneously and overlap (e.g., share processing circuits). In some implementations, a same virtual pipe can wrap around and overlap with itself to enable an arbitrarily long virtual pipe. In some implementations, virtual pipes can be selected based on the collective properties (e.g., size and expected invocation frequency) of the combined tasks (in some implementations, computer-readable instructions) to be performed by the PPC 116. In some implementations, the user can configure a PPC 116 to add or subtract active programs and reconfigure the virtual pipes at runtime. In some implementations, a PPC 116 may operate without or with minimal, generic commands from a user that may not detail or provide all the desired processing operations to the PPC 116.

As will be discussed in more detail with respect to FIG. 2, in some implementations, at runtime, a task description may be passed from one processing circuit to another through Task controller 102. In some such implementations, at every hop the Task controller 102 can inspect the task description (as modified by the last processing circuit) to direct it to the next processing circuit.

In some of those implementations, the PPC 116 can analyze the task description to choose the processing circuit (or sequence of processing circuits) and update the task context (e.g., in context page 120) to be used in subsequent processing steps. PPC 116 may analyze and process a message associated with the task description multiple times throughout the processing sequence. In some implementations, PPC 116 can mix and match processing steps (e.g, parsing, editing, de-parsing, lookup, etc.) as programmed or otherwise configured. In some implementations, PPC 116 can access/obtain and/or modify various data types (e.g., packets, contexts, state tables, etc.). In some implementations, PPC 116 can access data multiple times during program (or task) execution thereby reducing or eliminating the need to preload data. In some implementations, PPC 116 can maintain high throughput in the presence of HoLB events (e.g., where a map lookup missed cache and must be fetched from external components). In some implementations, PPC 116 can automatically track the progress of a large number of data flows and can allow messages/tasks belonging to unrelated flows to continue processing and pass each other to bypass stalled messages/tasks due to the HoLB event.

In some aspects, PPC 116 can include a map access circuit to bridge elements of the PPC 116 with lookup table implementations. The map access circuit can facilitate access to the tables and enable other advance operations such as partial table entry accesses and atomic read-modify-write operations over mutable table entries. The map access circuit can be used to resolve conflicts at runtime without the need for locks on table entry. In some implementations, the map access circuit can support atomic map operations (e.g., a set of operations that must be completed without interruption to be successful). In some implementations, a message being processed by PPC 116 can effect a change in elements of the PPC 116 (e.g., a message can update a map entry such as a counter) which can create access collisions when multiple components try to access or use the changed element. In those implementations, the map access circuit can offload the operation and resolve any contentions internally by collecting modification requests to the same entry and updating the entry.

In some aspects, PPC 116 can include a flow cache. A flow cache can include data lanes or channels that hold messages and/or maps that have been read from or will be written back to external memories. In some implementations, a data lane can be a message data lane corresponding to a message that has been read in from memory and will be written back into memory. In some implementations, a map data lanes can be a data lane for results of lookups performed in corresponding memories. In some implementations, the flow cache can buffer data from external memories for use by PPC 116 to avoid continuous accesses to these memories.

Although illustrated as separate elements, the system 100 in FIG. 1 can represent portions of a single module or application.

As discussed above, in certain implementations, the system 100 in FIG. 1 can represent one or more hardware elements executing software applications or programs to perform one or more tasks. For example, and as will be described in greater detail below, the system 100 can include modules stored and configured to run on one or more computing devices. The system 100 in FIG. 1 can also represent all or portions of one or more special-purpose computers configured to perform one or more tasks.

FIG. 2 is a block diagram of an example system for task management. In some implementations, the system 200 of FIG. 2 can be included within a chip, such as an integrated circuit, system on a chip (SoC), or other chip. In some cases, the chip can be a processing unit, such as a data processing unit (DPU), central processing unit (CPU), or graphics processing unit (GPU).

In some implementations, system 200 can be configured to perform operations on task descriptions associated with respective messages. In some implementations, system 200 includes a task controller 202 for routing or otherwise managing task descriptions between components of system 200. In some implementations, task controller 202 can be an example implementation of a Task controller 102 as discussed in relation to FIG. 1.

In some aspects, task controller 202 can act as a switch to route task descriptions between components and arbitrate between conflicting task descriptions. The task controller 202 can route task descriptions to subsequent hops in a processing sequence. The task controller 202 can also enforce security & bandwidth policies.

As noted herein, the task description can include a flow identifier for a data flow between components, processing circuits, and memory. In some implementations, the flow identifier can include a source identifier (e.g., a port number of a port of the controller) and a source channel (e.g., a queue identifier of a task queue). In some aspects, to enforce access controls the task controller can double check whether a given task description can be routed to a given component based on the flow identifier. In some implementations, the flow identifier can be checked against a predetermined mask and if the comparison fails, access to a component can be denied.

In some aspects, task controller 202 can schedule work to avoid HoLB events. In a HoLB event, a first task description or task in a task queue (e.g., the head of the queue) cannot be processed or otherwise holds up the processing of subsequent task descriptions or tasks. In such events, task controller 202 can allow messages/tasks belonging to unrelated flows to continue processing and pass each other to bypass stalled messages/tasks. In some aspects, task controller 202 can provide telemetry or status updates regarding a given task.

In some aspects, a task controller 202 can receive a task description from a component, inspect the task description content, and queue the task description to the next component. In some implementations where system 100 or system 200 are implemented along other systems, the task controller 102 or task controller 202 can pass the task description to another task controller in another system 100. In some implementations, the task controller 202 can route a task by looking up one or more fields (e.g., the source component where the task description came from, flow identifier) in a table of information regarding routing of tasks.

In some aspects, task controller 202 can arbitrate between tasks found at the heads of tasks queues leading to each component. In some implementations, the arbitration function is performed independently and/or in parallel for each component. In some implementations, for each component, task controller 202 can determine which tasks are eligible to continue processing, arbitrates between all the eligible tasks, dequeues the selected task, and passes it to the component.

In some aspects, a task's eligibility for processing is determined by the resources that the task may use to complete the next processing operation without stalling (or in some cases being able to progress with a sufficiently low probability of stalling). In some aspects, the task description can indicate to the task controller 202 or allow the task controller 202 to determine which resources will be used by the task.

In some implementations, task controller 202 can be operatively connected to one or more special processing circuits (SPCs) such as SPC 0 212-218, one or more processing circuits (PCs) such as PC 0 204-206, a DMA processing circuits such as DMA 208, and a network interface (Net 210). An SPC can be a processing circuit capable of performing specific operations such as parse, lookup, and edit. In some implementations, an SPC can be programmable. In some implementations, task controller 202 includes a plurality of ports to interface with other components of system 200. In some implementations, each port can be bidirectional. In some implementations, task controller 202 can send or receive a task description in each port in each clock cycle. In some implementations, a component of system 200 can be communicatively coupled to a plurality of ports of task controller 202. In some implementations, one or more ports of task controller 202 can be operatively connected to a processing circuit.

In some implementations, task controller 202 can create internal paths between components. In some implementations, the paths can be created during configuration or reconfiguration of the task controller 202. In some implementations, task controller 202 can create more than one path between components to, for example, prioritize task descriptions or create virtual channels/paths.

In some aspects, task controller 202 can include internal memory to receive and store data from components. In some implementations, the internal memory can be physical or virtual memory. Examples of internal memory include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some aspects, one or more of components 204-218 can consume and generate task descriptions. In some implementations, a component consuming a task description may trigger a process or operation by the component and, in turn, can produce zero or more task descriptions. In some implementations, a component consuming one task description may generate another task description.

In some aspects, a task description can be a data structure. In some aspects, the task is an entity embedded in the task description. As noted herein, in some implementations, the task description can allow task controller 202 and components of system 200 to track the progress of a task from one discrete item of work performed by a component (e.g., processing circuit) to the next item of work performed by another or possibly the same component. For example, in some implementations, a PPC (e.g., PPC 116) can execute a subroutine over a message then, another component can process the message, and an I/O circuit (e.g., IOPC DMA 106) sends the message to a DMA queue.

In some aspects, system 100 or system 200 can receive explicit request from a user to create certain tasks. In some aspects, system 100 or system 200 may create the task as an outcome of a condition or an event. For example, in some implementations, a user command can initiate a task and triggers the creation of a task description. As another example, in some implementations, a task and the corresponding task description can be created when a network message arrives from another component, without requiring any user input.

In some aspects, the task description can be referred to as a task structure. In some implementations, the task description can be a data structure. In some implementations, the task description can have a fixed length (e.g., 64 bits, 128 bits). In some implementations, a task description can be defined by the specific hardware implementation of system 200. While in some implementations, a task can be associated with a corresponding message, the disclosure is not so limited. For example, in some implementations, a task can be a fetch request from DMA (e.g., DMA 208). In those implementations, the task description is not associated with any specific message.

In some implementations, a task description can include a message pointer identifying a location in memory (e.g., memory 104) where a message, message data, and/or message metadata associated with the task is stored. In some implementations, a task description can include a context pointer identifying the location in memory where task context associated with the task corresponding to the task description is stored. In some implementations, a task description can include an offset field that indicates to the components how to interpret the task context's contents. In some implementations, a task description can include a task context format specifier to enable resource or component chaining.

In some implementations, a task description can include a flow identifier (“flow id”). A flow id can be an implementation defined value. In some implementations, the flow id can be a structured bitfield. In some of those implementations, the top bits of the bitfield can identify a domain (e.g., a network domain, a storage domain). In some implementations, the number of bits for the flow id can be configured during initialization.

In some aspects, when two components are operatively connected by the task controller 202 at least one task queue (TQ) can be implemented between the components. In some implementations, task queues can be a FIFO queue going from one component to another. In some implementations, more than one task queues can be implemented between two components. In some implementations, one or more task queues can be implemented in parallel. In some of those implementations, one or more virtual channel (VC) can be implemented. In some implementations, task queues can be implemented as linked lists to enable dynamic sizing of the queue to grow and shrink up to a configurable min/max. In some implementations, all task paths and channels between components can be known at initialization.

In some implementations, components can process tasks in task queues with same flow ids in order. In some implementations, components can reorder tasks with different flow ids. In some implementations, a component can modify a flow id. For example, messages from Net 210 can be identified more precisely after having been processed (e.g., parsed) and the flow id can be modified accordingly. In some implementations, if a task has its flow id modified from A to B, any ordering constraints will be lost with respect to other tasks with flow id A.

In some implementations, the number of channels or paths between components can be variable. In some of those implementations, each task can be assigned to a channel based on its most significant bits.

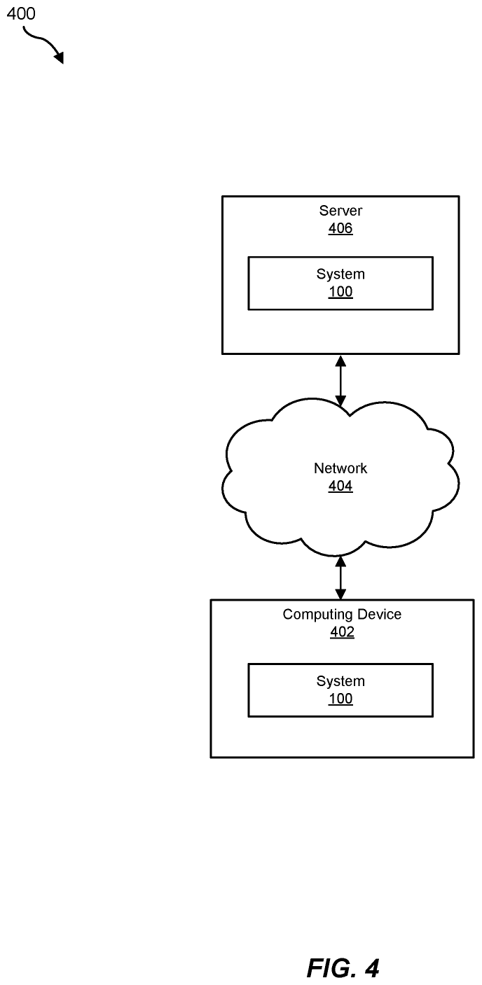

FIG. 3 illustrates a flow diagram for an example method 300 for managing tasks. The Steps shown in FIG. 3 can be performed by any suitable computer-readable code and/or circuit arranged to perform the computer-implemented method 300, including system 100 in FIG. 1, system 200 in FIG. 2 and system 400 in FIG. 4, and/or variations or combinations of one or more of the same. In one example, each of the steps shown in FIG. 3 can represent an algorithm whose structure includes and/or is represented by multiple sub-Steps, examples of which will be provided in greater detail below.

In some aspects, method 300 describes managing performance of a task on a message by a plurality of circuits of a processing device. In some implementations, the task can comprise a sequence of processings to be performed on the message. In some implementations, the task can comprise each circuit of the plurality of circuits performing a processing of the sequence of processings on the message.

In some implementations, the method 300 can be performed by a task controller communicatively coupled to each circuit of the plurality of circuits. In some implementations, each circuit of the plurality of circuits is communicatively coupled to the task controller via one or more interfaces (e.g., a port). In some aspects, each circuit of the plurality of circuits can comprise one or more queues for output of tasks that are to be passed to one or more other circuits of the plurality of circuits.

As illustrated in FIG. 3, at Step 302, a task controller (e.g., task controller 102 or task controller 202) can receive a first information (e.g., a task description) from a processing circuit or some of other component of system 100 or system 200. In some aspects, the first information can correspond to a task to be performed by a processing circuit or some other component on the message. As noted herein, while the first information can be associated with a message, other received information do not have to be associated with a message. In some aspects, the first information can be automatically generated by the processing circuit or manually requested from a processing circuit by a user.

In some aspects, the first information can identify a sequence of processings or operations to be performed on the task and the processing circuits or other component to perform the processings. In some embodiments, the first information can identify the sequence of processings and the circuits or components to perform the processings by providing a processing circuit with information for accessing a task context associated with the task in a context page (e.g., context page 120) in shared memory (e.g., memory 104). As noted, the circuits or components can be operatively connected to the shared memory. In some aspects, the first information can include a context pointer identifying the location in memories 104 of the context page and/or the task context. In some aspects, the processing circuit can extract the context pointer from the first information and interface with the memory to obtain the task context.

At Step 304, the task controller can route the first information to a receiving processing circuit (e.g., a first circuit). The receiving processing circuit or first circuit may or may not be the same processing circuit that provided the first information to the task controller. In some aspects, the first circuit can be a PPC (e.g., PPC 116) as discussed in FIG. 1. In some aspects, routing to a circuit of the plurality of circuits can comprise routing to an interface or port of the circuit from a queue of another circuit of the plurality of circuits.

In some aspects, the task controller can route the first information based on the sequence of proceedings identified for the task. In some implementations, the data path from the initial circuit to the first circuit was defined prior to runtime. In some of those implementations, the task controller directs the first information from the initial circuit to the first circuit through the predetermined data path.

In some aspects, the task controller can analyze the first information and extract a flow identifier. In some implementations, the task controller can route the first information based on the flow identifier.

At Step 306, the task controller can receive from the first circuit an output of the first processing. In some aspects, the output of the first processing is another or second information. In some aspects, the first circuit can generate the second information based on the first information. In some aspects, the circuit can generate the second information by modifying a flow identifier of the first information.

At Step 308, the task controller can route, based on the sequence of processings identified for the task, the second information regarding the task to a second circuit of the plurality of circuits to perform a second processing that follows the first processing in the sequence of processings. In some aspects, the task controller can route the second information based on the flow identifier of the second information.

Example systems 100-200 can be implemented in a variety of ways. For example, all or a portion of example systems 100-200 can represent portions of example system 400 in FIG. 4. As shown in FIG. 4, system 400 can include a computing device 402 in communication with a server 406 via a network 404. In one example, all or a portion of the functionality of the systems 100-200 can be performed by computing device 402, server 406, and/or any other suitable computing system. As will be described in greater detail below, the system 400 from FIG. 4 can, when executed by at least one processor and/or circuit of the computing device 402 and/or server 406, enable computing device 402 and/or server 406 to conduct task and/or message management.

Computing device 402 generally represents any type or form of computing device capable of reading computer-executable instructions and task and/or message management. For example, the computing device 402 can include a network interface controller (NIC) that includes the system 100 or system 200. Additional examples of computing device 402 include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device.

Server 406 generally represents any type or form of computing device that is capable of task and/or message management. For example, the server 406 can include a network interface controller (NIC) that includes one or more of the systems 100-200 of FIG. 1 and FIG. 2. Additional examples of the server 406 include, without limitation, storage servers, database servers, application servers, and/or web servers configured to run certain software applications and/or provide various storage, database, and/or web services. Although illustrated as a single entity in FIG. 4, the server 406 can include and/or represent a plurality of servers that work and/or operate in conjunction with one another.

The network 404 generally represents any medium or architecture capable of facilitating communication or data transfer. In one example, network 404 can facilitate communication between computing device 402 and server 406. In this example, network 404 can facilitate communication or data transfer using wireless and/or wired connections. Examples of network 404 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems can be connected to one or more of systems 100-400 of FIGS. 1-4. Conversely, all the components and devices illustrated in systems 100-400 need not be present to practice the implementations described and/or illustrated herein. The devices and subsystems referenced above can also be interconnected in different ways from that shown in FIG. 4. Systems 100-400 of FIGS. 1-4 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of steps described and/or illustrated herein are given by way of example only and can be varied as desired. For example, while the Steps illustrated and/or described herein can be shown or discussed in a particular order, these Steps do not necessarily need to be performed in the order illustrated or discussed. The various example methods described and/or illustrated herein can also omit one or more of the Steps described or illustrated herein or include additional Steps in addition to those disclosed.

While various implementations have been described and/or illustrated herein in the context of fully functional computing systems, one or more of these example implementations can be distributed as a program product in a variety of forms, regardless of the computer-readable media used to carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various implementations of the examples disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the embodiments have been described with reference to specific exemplary embodiments thereof. It will, however, be evident that various modifications and changes may be made thereto without departing from the broader spirit and scope of the embodiments as set forth in the appended claims. The specification and drawings are, accordingly, to be regarded in an illustrative sense rather than a restrictive sense.

What is claimed is:

1. A method comprising:
managing performance of a task on a message by a plurality of circuits of a processing device, the task comprising a sequence of processings to be performed on the message and each circuit of the plurality of circuits performing a processing of the sequence of processings, the managing performance of the task comprising:
routing, based on the sequence of processings for the task, first information regarding the task to a first circuit of the plurality of circuits to perform a first processing of the sequence of processings on the message;
receiving, from the first circuit, an output of the first processing; and
routing, based on the sequence of processings identified for the task, second information regarding the task to a second circuit of the plurality of circuits to perform a second processing that follows the first processing in the sequence of processings.

2. The method of claim 1, wherein:
the method is performed by a controller communicatively coupled to each circuit of the plurality of circuits, wherein each circuit of the plurality of circuits is connected to the controller via one or more interfaces;
wherein each circuit of the plurality of circuits comprises one or more queues for output of tasks that are to be passed to one or more other circuits of the plurality of circuits; and
routing to a circuit of the plurality of circuits comprises routing to an interface of the circuit from a queue of another circuit of the plurality of circuits.

3. The method of claim 1, wherein:
the task is a first type of task, the first type of tasks comprising the sequence of processings performed with the plurality of circuits; and
a second type of task comprises a second sequence of processings performed with at least some of the plurality of circuits, the second sequence of processings being different from the sequence of processings.

4. The method of claim 1, wherein:
the task is one of a plurality of tasks, the plurality of tasks organized into at least a first flow of tasks;
managing performance of the task comprises selecting, at a time, between one or more tasks for which information is to be routed to circuits of the plurality of circuits for processing; and
managing performance of the task comprises ensuring that tasks of the first flow of tasks are processed by circuits of the plurality of circuits according to an order of the tasks in the first flow.

5. The method of claim 1, wherein:
the message comprises a command and/or data;
the task comprises a task description comprising information regarding performance of the task; and
routing the first information regarding the task to the first circuit and the second information regarding the task to the second circuit comprises routing, at a time, at least some of the task description at the time.

6. The method of claim 5, wherein:
each of the plurality of circuits is communicatively coupled to a shared memory;
the command and/or the data for the message is stored in a message buffer in the shared memory;
the information regarding performance of the task is stored in the shared memory separate from the command and/or the data; and
the task description comprises a pointer to a location storing the information regarding performance of the task, a pointer to the command and/or data, and/or a flow identifier identifying a flow of tasks with which the task is associated.

7. The method of claim 6, wherein:
the first circuit edits the flow identifier for the task; and
the second information regarding the task has a different flow identifier for the task than the first information regarding the task.

8. The method of claim 7, wherein routing the first and second information regarding the task to the first circuit and the second circuit, respectively, comprises looking up the flow identifier in a table of information regarding routing of tasks.

9. The method of claim 1, wherein the first circuit is a programmable processing circuit.

10. The method of claim 1, further comprising:
receiving the message from a network.

11. A non-transitory computer-readable storage medium for storing instructions executable by a processor, the instructions comprising:
managing performance of a task on a message by a plurality of circuits of a processing device, the task comprising a sequence of processings to be performed on the message and each circuit of the plurality of circuits performing a processing of the sequence of processings, the managing performance of the task comprising:
routing, based on the sequence of processings for the task, first information regarding the task to a first circuit of the plurality of circuits to perform a first processing of the sequence of processings on the message;
receiving, from the first circuit, an output of the first processing; and
routing, based on the sequence of processings identified for the task, second information regarding the task to a second circuit of the plurality of circuits to perform a second processing that follows the first processing in the sequence of processings.

12. The non-transitory computer-readable storage medium of claim 11, wherein:
the instructions are performed by a controller communicatively coupled to each circuit of the plurality of circuits, wherein each circuit of the plurality of circuits is connected to the controller via one or more interfaces;
wherein each circuit of the plurality of circuits comprises one or more queues for output of tasks that are to be passed to one or more other circuits of the plurality of circuits; and
routing to a circuit of the plurality of circuits comprises routing to an interface of the circuit from a queue of another circuit of the plurality of circuits.

13. The non-transitory computer-readable storage medium of claim 11, wherein:
the task is a first type of task, the first type of tasks comprising the sequence of processings performed with the plurality of circuits; and
a second type of task comprises a second sequence of processings performed with at least some of the plurality of circuits, the second sequence of processings being different from the sequence of processings.

14. The non-transitory computer-readable storage medium of claim 11, wherein:
the task is one of a plurality of tasks, the plurality of tasks organized into at least a first flow of tasks;
managing performance of the task comprises selecting, at a time, between one or more tasks for which information is to be routed to circuits of the plurality of circuits for processing; and
managing performance of the task comprises ensuring that tasks of the first flow of tasks are processed by circuits of the plurality of circuits according to an order of the tasks in the first flow.

15. The non-transitory computer-readable storage medium of claim 11, wherein:
the message comprises a command and/or data;
the task comprises a task description comprising information regarding performance of the task; and
routing the first information regarding the task to the first circuit and the second information regarding the task to the second circuit comprises routing, at a time, at least some of the task description at the time.

16. The non-transitory computer-readable storage medium of claim 15, wherein:
each of the plurality of circuits is communicatively coupled to a shared memory;
the command and/or the data for the message is stored in a message buffer in the shared memory;
the information regarding performance of the task is stored in the shared memory separate from the command and/or the data; and
the task description comprises a pointer to a location storing the information regarding performance of the task, a pointer to the command and/or data, and/or a flow identifier identifying a flow of tasks with which the task is associated.

17. The non-transitory computer-readable storage medium of claim 16, wherein:
the first circuit edits the flow identifier for the task; and
the second information regarding the task has a different flow identifier for the task than the first information regarding the task.

18. The non-transitory computer-readable storage medium of claim 17, wherein routing the first and second information regarding the task to the first circuit and the second circuit, respectively, comprises looking up the flow identifier in a table of information regarding routing of tasks.

19. The non-transitory computer-readable storage medium of claim 11, wherein the first circuit is a programmable processing circuit.

20. A device comprising:
a circuit configured to perform a method comprising managing performance of a task on a message by a plurality of circuits of the device, the task comprising a sequence of processings to be performed on the message and each circuit of the plurality of circuits performing a processing of the sequence of processings, the managing performance of the task comprising:
routing, based on the sequence of processings for the task, first information regarding the task to a first circuit of the plurality of circuits to perform a first processing of the sequence of processings on the message;
receiving, from the first circuit, an output of the first processing; and
routing, based on the sequence of processings identified for the task, second information regarding the task to a second circuit of the plurality of circuits to perform a second processing that follows the first processing in the sequence of processings.
